(19) United States
(12) Patent Application Publication
(10) Pub. No.: US 2009/0027717 A1
(43) Pub. Date: Jan. 29, 2009

(54) SYSTEM AND METHOD FOR TRANSFERRING IMAGES AMONG SPECTRUM AGILE RADIO DEVICES WITHOUT RETRANSMITTING IMAGES

(75) Inventor: Yasser Alsafadi, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,268

(22) PCT Filed: Jun. 19, 2006
(86) PCT No.: PCT/IB06/51965

§ 371 Date: Dec. 20, 2007

Related U.S. Application Data
(60) Provisional application No. 60/692,165, filed on Jun. 20, 2005.

(51) Int. Cl. G06F 15/00

(52) U.S. Cl. 358/1.15

(57) ABSTRACT

A system and method for transferring images among spectrum agile radio devices without the need to retransmit image data. The system and method of the invention encodes and transmits packets so as to permit the efficient recovery of image data that is lost during transmission without the need to retransmit the packets. Instead of encoding packets containing adjacent pixels and transmitting them line-by-line, the system and method of the present invention encodes and transmits packets containing pixels from non-adjacent areas of a frame. As a result, any losses that occur within an individual packet are distributed throughout the image rather than in a specific line or isolated region of the image. This permits the efficient recovery of image data that is lost during transmission without the need to retransmit the data.

The present invention relates to image processing and, more particularly, to a system and method for transferring images among spectrum agile radio devices without the need to retransmit image data.

Tele-radiology and Picture Archiving and Communication Systems (PACS) have benefited from high speed networks and efficient protocols, such as Transmission Control Protocol Internet Protocol (TCP/IP), which can deliver images impeccably (i.e., without any data loss) and in a timely manner. TCP is one of the main protocols in TCP/IP networks. TCP enables two hosts to establish a connection and exchange streams of data. TCP guarantees delivery of data, and also guarantees that packets will be delivered in the same order in which they were sent. However, these requirements are inflexible with respect to wireless networks. For example, the rigid requirement for perfect data delivery without data loss hinders the deployment of a certain class of radiology applications over a wireless network. These applications operate in a wireless environment having a low bandwidth and noisy spectrum. Furthermore, such applications do not require the presentation of perfect images in order for medical personnel to make clinical observations or judgments with respect to patients, such as checking for tube placement in the patient's chest using chest x-ray images.

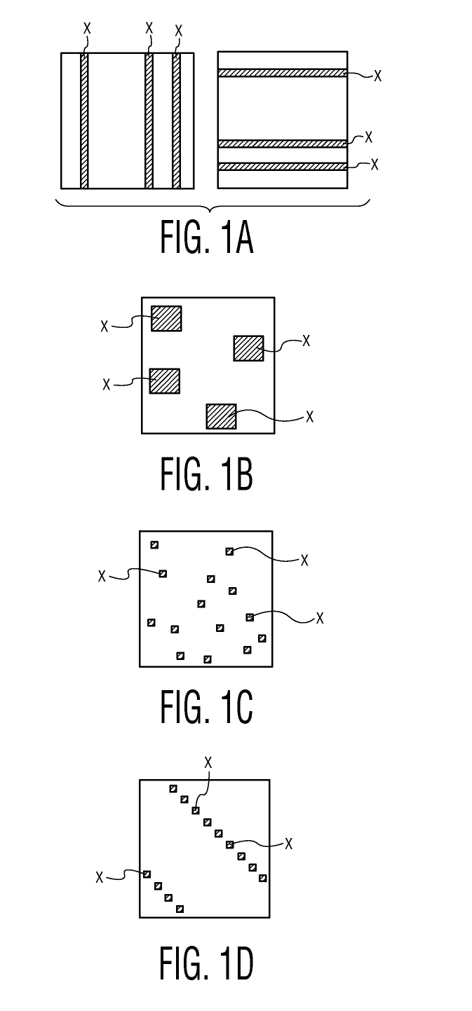

Images are transmitted using encoding algorithms, which control the placement of pixels from the images into packets/frames. Typically, images are encoded in packets containing pixels which are adjacent to each other, and these packets are transmitted sequentially in a line-by-line manner. Loss of a given packet can result in loss of entire line in the displayed image, or if consecutive packets are lost, a blurring in a sub-region of the displayed image will occur. The exact nature of the loss in the displayed images, as shown in FIGS. 1(a) thru 1(d), will depend on the type of the encoding algorithm used, such as raster based encoding (FIG. 1(a)), block based encoding (FIG. 1(b)), random scattered FIG. 1(c) or regular scattered encoding (FIG. 1(d)). In each figure, the data loss is shown as the shaded area X. If losses occur in a diagnostically relevant region, crucial information may be lost which could result in a medical misdiagnosis.

Wireless protocols will lose packets/frames at any time because of errors in transmission. This frame loss is often “bursty” in nature, i.e., two or more back-to-back packets are lost. Wireless protocols employ different mechanisms to recover data losses. Examples of such mechanisms are Positive Acknowledgement with Retransmission (PAR) and Automatic Repeat request (ARQ). These mechanisms involve the re-transmission of the corrupted or unreceived frames. However, re-transmissions cause a decrease in data throughput. This decrease in data throughput becomes more pronounced in noisy transmission environments.

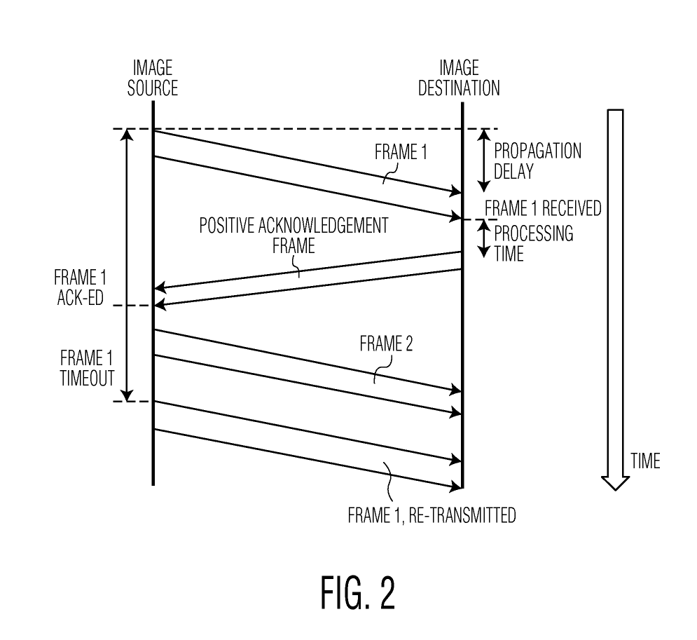

FIG. 2 is an illustration of an exemplary protocol for positive acknowledgement and re-transmission of frames. With reference to FIG. 2, an “Image Source” sends Frame 1, sets a timeout timer, and waits for one of two events to occur. The first event is the receipt of a frame from the “Image Destination” containing a positive acknowledgement of the receipt of Frame 1. Next, the Image Source repeats the process of setting the time out timer, and sends Frame 2. The second event that the Image Source waits for is the expiration of the timeout timer. This permits the Image Source to recognize that, up to this point, an acknowledgement of the proper receipt of Frame 1 was not received. As a result, the Image Source retransmits Frame 1 based on the failure to receive the acknowledgement. More sophisticated error control mechanisms are known. However, the retransmission of a frame is still a time consuming process. Moreover, errors are always prone to occur in wireless environments.

The present invention is a system and method for transferring images among spectrum agile radio devices without the need to retransmit image data. The present system and method of the invention encodes and transmits packets so as to permit the efficient recovery of image data that is lost during transmission without the need to retransmit the data.

Instead of encoding packets containing adjacent pixels and transmitting them line-by-line, the system and method of the present invention encodes and transmits packets containing pixels from non-adjacent areas of a frame. As a result, any losses that occur will be distributed throughout the image rather than in a specific line or isolated region of the image. Available options for data recover are described in Turner et al. “Image Transfer: an end-to-end design.” SIGGCOMM '92, Baltimore, Md., August 1992.

The present inventors have observed that a loss of up to 15% of image data can be tolerated without affecting the diagnostic reliability of the image data. As part of a study performed by the present inventors, radiologists were asked to view individual mammographic images each having a 0%, 15% and 25% loss of image data, respectively. The radiologists then reported on the presence or absence of a mass lesion or a cluster of micro-calcifications. The study used mammographic images containing subtle micro-calcification clusters. Micro-calcification clusters can be small enough such that if packet losses were to occur, individual micro-calcifications or even a significant part of a whole cluster could be eliminated from the image. This could result in the failure of the radiologist to detect lesions or, if detected, deciding that a lesion was more likely to be benign than malignant. The study showed that the loss of up to 15% of the number of packets (i.e., lost packets were not retransmitted) would not affect the diagnostic accuracy of radiologists.

In accordance with the present invention, an image description module is used to provide a description of the image to be transferred to a spectrum agile radio device. The information contained in the image description module is formatted in accordance with Digital Imaging and Communication in Medicine (DICOM) Information Object Definition (IOD). This module contains information, such as the RowLength and ColumnLength for the image pixels of a packet. A transmission characteristics module which contains data is used to provide a description of the current transmission opportunity for a spectrum agile radio, such as the protocol parameters and characteristics of the environment surrounding the device. A data link requirements module is used to store data representing relationships between image parameters, transmission protocol, and data link settings.

A reasoner module obtains transmission characteristics parameters from the transmission characteristics module, image description parameters from the image description module, and data link requirements parameters from the data link requirements module, and uses these parameters to generate frame settings, such as Packet/Byte offsets, which are used to ensure that no two adjacent image pixels are placed in the same transmitted frame.

The present invention decreases the costs associated with the manufacture of spectrum agile radio devices since they do not require a transmitting device to buffer an image for subsequent retransmissions of the image data. Additionally, faster image transmission is possible, since the need to wait for acknowledgements and retransmissions is eliminated.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

The foregoing and other advantages and features of the invention will become more apparent from the detailed description of the exemplary embodiments of the invention given below with reference to the accompanying drawings in which:

FIGS. 1(a) thru 1(d) are an illustration of the effects of frame/packet losses on an image;

FIG. 2 is an illustration of an exemplary protocol for positive acknowledgement and re-transmission of frames;

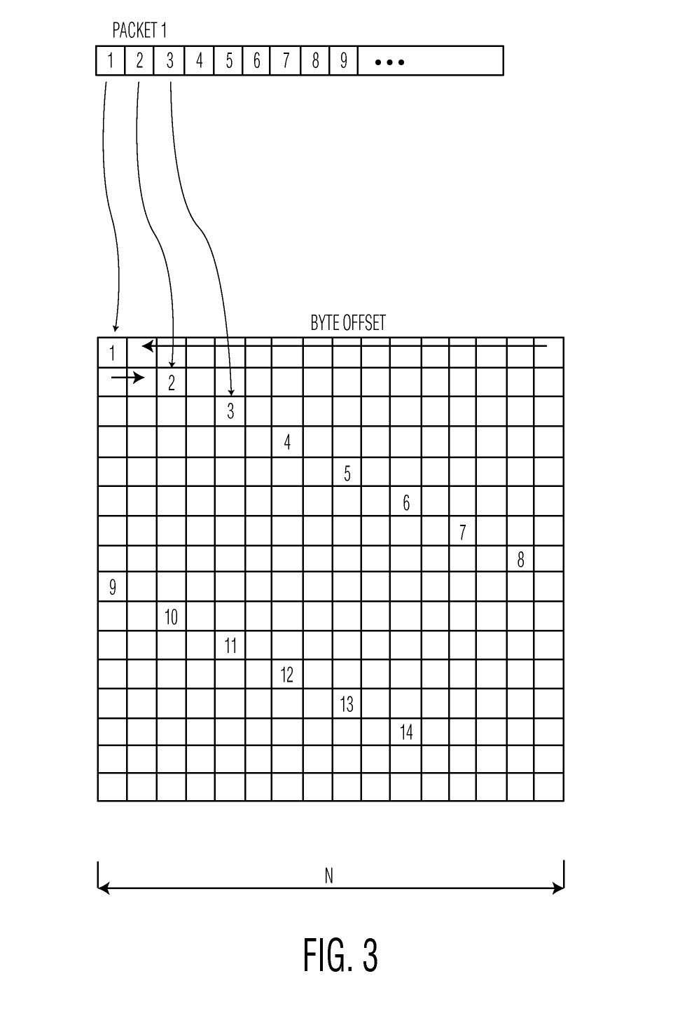

FIG. 3 is an exemplary illustration of the use of a parameter for ensuring that no two bytes within the same packet are adjacent in an image space;

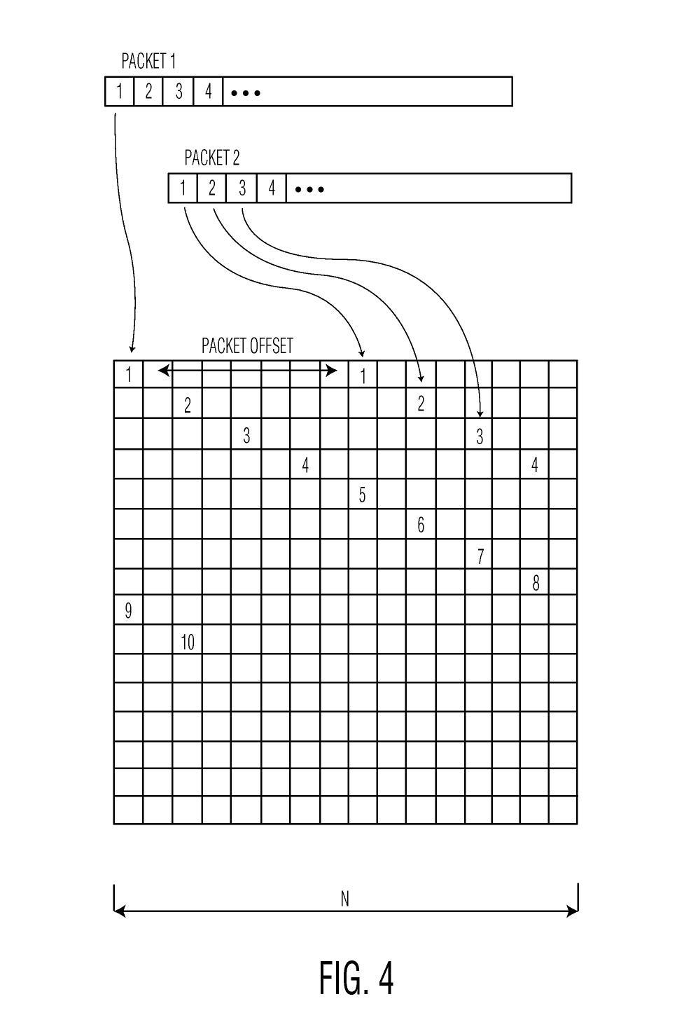

FIG. 4 is an exemplary illustration of the use of a parameter for controlling how far apart temporally adjacent frames are within an image space; and

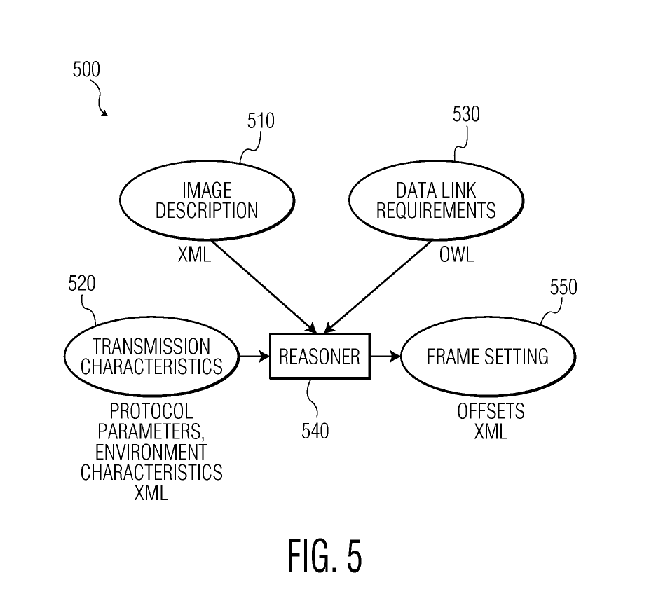

FIG. 5 is a schematic block diagram illustrating the system for generating appropriate frame settings for transmitting images.

The present invention is a system and method for transferring images among spectrum agile radio devices without the need to retransmit image data. A spectrum agile radio is a device that can change its transmitter parameters based on interaction with the environment in which it operates. This interaction may involve active negotiation or communications with other spectrum users and/or passive sensing and decision making within the device. The spectrum agile radio selects the bandwidth that is present at a given opportunity that a monitor located within the spectrum agile radio can use.

In accordance with the invention, sophisticated, high speed encoding mechanisms are used to encode transmitted images in “regular-scattered” frames. Lost pixels are recovered using four-neighbor interpolation. That is, four sequential pixels within a frame are used to perform the interpolation. As a result, it is possible to lose a plurality of frames without affecting the reliability of the images for diagnostic purposes or the ability of a radiologist to accurately diagnose a patient's illness based on the images.

FIG. 3 is an exemplary illustration of the use of a parameter for ensuring that no two bytes within the same packet are adjacent in an image space. Here, pixels are assigned to packets using a parameter, such as ByteOffset which equals RowLength+2. FIG. 4 is an exemplary illustration of the use of a parameter for controlling how far apart temporally adjacent frames are within an image space.

With an image size of RowLength multiplied by ColumnLength pixels, regular scattered encoding is implemented based on key parameters, preferable two parameters, i.e., ByteOffset and PacketOffset. Here, ByteOffset is used to control how bytes within a single frame are distributed throughout an image group of N transmitted frames. ByteOffset is also used to establish the number of bytes between adjacent pixels in an identical frame. Hence, ByteOffset ensures that no two bytes within the same packet are ever adjacent in an image space, as illustrated in FIG. 3.

As shown in FIG. 3, Packet 1 of bytes is encoded in the image group of N transmitted frames at a predefined ByteOffset interval, e.g., 2. With further reference to FIG. 3, this causes dispersal of the bytes within frames of the image group of N transmitted frames at an interval of every two frames.

PacketOffset is used to alleviate the problems associated with “bursty” frame losses. That is, PacketOffset is used to establish the number of bytes between starting pixels of adjacent packets. Hence, the PacketOffset parameter controls how far apart temporally adjacent frames are within an image space, as illustrated in FIG. 4. Hence, ByteOffset and PacketOffset ensure that no two adjacent image pixels will ever be in the same transmitted frame. That is, in two packets within the same group of N transmitted frames, no two adjacent image pixels will ever be in the same transmitted frame.

As shown in FIG. 4, Packet 1 of bytes is encoded in the image group of N transmitted frames at a predefined ByteOffset and the PacketOffset, e.g., 2+4. With additional reference to FIG. 2, Packet 2 of bytes is encoded in the image group of N transmitted frames at the predefined interval of ByteOffset and PacketOffset, e.g., 2+4. In accordance with the invention, this ensures dispersal of the bytes in a manner such that no two adjacent image pixels are ever located in the same transmitted frame. Naturally, a person skilled would appreciate that other coding schemes may be used to encode the packet or frames such that no two adjacent image pixels are located in the same transmitted frame.

FIG. 5 is a schematic block diagram illustrating a system 500 for generating appropriate frame settings for transmitting images in accordance with the present invention. Here, the frame settings are applied to frames containing image data so as to encode and transmit packages from non-adjacent areas of the data. With reference to FIG. 5, image description module 510 provides a description of the image to be transferred to a spectrum agile radio device. The information contained in image description module 510 is formatted in accordance with Digital Imaging and Communication in Medicine (DICOM) Information Object Definition (IOD). Module 510 contains information, such as the RowLength and ColumnLength for the image pixels. In the present invention, these parameters can be expressed in Extensible Markup Language (XML).

The transmission characteristics module 520 contains data that is used to provide a description of the current transmission opportunity for a spectrum agile radio, such as the protocol parameters and characteristics of the environment surrounding the device. In the present invention, these parameters can also be expressed in Extensible Markup Language (XML).

Data link requirements module 530 contains data representing relationships between image parameters, transmission protocol parameters, and data link settings parameters. In the present invention, the data is constructed using the Web Ontology language (OWL). OWL is designed to defined such that it is compatible with the architecture of the World Wide Web, and in particular the Semantic Web. OWL uses both uniform resource locators (URIs) and the description framework for the Web provided by RDF to add the following capabilities to ontologies: the ability to be distributed across many systems, scalability to Web needs, compatibility with Web standards for accessibility and internationalization openess and extensiblility. OWL builds on Resource Description Framework (RDF) and RDF Schema and adds more vocabulary for describing properties and classes: among others, relations between classes (e.g. disjointness), cardinality (e.g. “exactly one”), equality, richer typing of properties, characteristics of properties (e.g. symmetry), and enumerated classes.

RDF Schema is a standard which describes how to use RDF to describe RDF vocabularies on the Web. An ontology is a formal and declarative representation which includes the vocabulary (or names) for referring to terms in a subject area, and the logical statements that describe what the terms are, how they relate to each other, and how they can or cannot relate to each other. An ontology provides a vocabulary for representing and communicating knowledge about some subject and a set of relationships that hold among the terms in the vocabulary, i.e., a hierarchy.

Reasoner module 540 is an inference engine which obtains the transmission characteristics from transmission characteristics module 520, the image description from image description module 510 and the data link requirements from data link requirements module 530, and uses these parameters to generate the frame settings 550, such as the Packet/Byte offsets, which are used to ensure that no two adjacent image pixels are placed in the same transmitted frame.

The system and method of the invention decreases the costs associated with the manufacture of devices, since the device is no longer required to buffer an image for subsequent retransmissions of the image data. Additionally, faster image transmission is achieved, since the need to wait for acknowledgements and retransmissions of image frames or packets is eliminated.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A system for transferring images among spectrum agile radio devices, comprising:
a reasoner module for generating frame settings which are used to ensure that no two adjacent image pixels are placed in an identical frame which is to be transmitted;
an image description module operatively coupled to the reasoner module for storing image description data;
a transmission characteristics module operatively coupled to the reasoner module for providing parameters and environment characteristics in which the spectrum agile radio is located; and
a data link module operatively coupled to the reasoner module for storing data representing relationships between at least one of image parameters, transmission protocol and data link settings.

2. The system of claim 1, wherein the frame settings are applied to frames containing image data so as to encode and transmit packages from non-adjacent areas.

3. The system of claim 1, wherein information contained in the image description module is formatted in accordance with Digital Imaging and Communication in Medicine (DICOM) Information Object Definition (IOD).

4. The system of claim 3, wherein the information is at least one of RowLength and ColumnLength values for image pixels.

5. The system of claim 3, wherein the information contained in the image description module is expressed in Extensible Markup Language (XML).

6. The system of claim 1, wherein the protocol parameters and environment characteristics provide a description of a current transmission opportunity for a spectrum agile radio device and environmental conditions in which the device is operated.

7. The system of claim 1, wherein the protocol parameters and environment characteristics are expressed in Extensible Markup Language (XML).

8. The system of claim 1, wherein the data representing relationships between image parameters, transmission protocol and data link settings is constructed using a Web Ontology language (OWL).

9. The system of claim 1, wherein the reasoner is an inference engine which obtains transmission characteristic parameters from the transmission characteristics module, image description parameters from the image description module and data link requirement parameters from the data link requirements module.

10. The system of claim 9, wherein the reasoner generates the frame settings based on the parameters.

11. The system of claim 1, wherein the frame settings are at least one of a PacketOffset value and a ByteOffset value.

12. The system of claim 10, wherein the frame settings are at least one of a PacketOffset value and a ByteOffset value.

13. The system of claim 12, wherein the PacketOffset and the ByteOffset values are used to ensure that no two adjacent image pixels are placed within an identical frame which is transmitted.

14. A method for transferring images among spectrum agile radio devices, comprising:
forwarding image description data which is stored in an image description module to a reasoner module;
forwarding parameters and environment characteristics in which the spectrum agile radio is located from a transmission characteristics module to the reasoner module;
forwarding data representing relationships between at least one of image parameters, transmission protocol and data link settings in a data link module to the reasoner module;
generating frame settings in the reasoner based on the descriptions of images, the parameters and environment characteristics and the stored data; and
encoding images based on the frame settings to ensure that no two adjacent image pixels are placed in an identical frame.

15. The method of claim 14, wherein the frame settings are applied to frames containing image data so as to encode and transmit packages from non-adjacent areas.

16. The method of claim 14, wherein information contained in the image description module is formatted in accordance with Digital Imaging and Communication in Medicine (DICOM) Information Object Definition (IOD).

17. The method of claim 13, wherein the information is at least one of RowLength and ColumnLength values for image pixels.

18. The system of claim 16, wherein the information contained in the image description module is expressed in Extensible Markup Language (XML).

19. The method of claim 14, wherein the protocol parameters and environment characteristics provide a description of a current transmission opportunity for a spectrum agile radio device and environmental conditions in which the device is operated.

20. The method of claim 14, wherein the protocol parameters and environment characteristics are expressed in Extensible Markup Language (XML).

21. The method of claim 14, wherein the data representing relationships between image parameters, transmission protocol and data link settings is constructed using a Web Ontology language (OWL).

22. The method of claim 14, wherein the reasoner module is an inference engine which obtains transmission characteristic parameters from the transmission characteristics module, image description parameters from the image description module and data link requirement parameters from the data link requirements module.

23. The method of claim 21; wherein the reasoner module generates the frame settings based on the parameters.

24. The method of claim 16, wherein the frame settings are at least one of a PacketOffset value and a ByteOffset value.

25. The method of claim 22, wherein the frame settings are at least one of a PacketOffset value and a ByteOffset value.

26. The method of claim 24, wherein the PacketOffset value and the ByteOffset value are used to ensure that no two adjacent image pixels are placed within an identical frame which is transmitted.
